(19) United States
(12) Patent Application Publication
(10) Pub. No.: US 2009/0256687 A1
(43) Pub. Date: Oct. 15, 2009

(54) MAGNETIC FIELD GUARD RINGS

(76) Inventors: William French, San Jose, CA (US); Peter J. Hopper, San Jose, CA (US); Kyuwoon Hwang, Palo Alto, CA (US)

Correspondence Address: Dergosits & Noah LLP (NSC);Counsel for National Semiconductor Corporation, Three Embarcadero Center, Suite 410, San Francisco, CA, 94111, US

(21) Appl. No.: 12/199,146

(22) Filed: Aug. 27, 2008

Related U.S. Application Data
(60) Provisional application No. 61/123,778, filed on Apr. 11, 2008.

(51) Int. Cl. G05B 11/01

(52) U.S. Cl. 340/310.17

(57) ABSTRACT

A magnetic guard ring is provided to reduce the susceptibility of a transformer-based data transmission to an externally generated magnetic field. The guard ring structure comprises strategically placed pieces of ferrite material, such as NiFe, that surround the transformer and “steer” the external magnetic field away from the transformer.

### PRIORITY CLAIM

This application claims the filing priority benefit of U.S. Provisional Application No. 61/123,778, filed on Apr. 11, 2008, titled “Magnetic Field Guard Rings.” Provisional Application No. 61/123,778 is hereby incorporated by reference herein in its entirety.

### FIELD OF THE INVENTION

The present invention relates to integrated circuit devices and, in particular, to techniques for protecting integrated circuit device structures from the influence of external magnetic fields.

### DISCUSSION OF THE RELATED ART

In the realm of factory automation, large machines that operate with high voltage systems are automated through the use of digital controllers that operate using a low voltage system to which an end user has access. The machine's high voltage systems and the controller's low voltage systems need to communicate. Therefore, there are a number of design criteria that must be met. First, the high voltage system and the low voltage system must have the ability to communicate information between each other at a high data rate (e.g., 100 Mbps). Second, there must be sufficient electrical isolation between the high voltage systems and the low voltage system to protect both the controller and the end user from such events as spikes and ground loops that may exceed 2500V. Third, there must be magnetic field immunity so that data is not corrupted.

There are currently four main technologies that can fulfill the above-stated requirements: optoelectronic coupling, capacitive coupling, inductive coupling and RF transmission/reception.

For many years, the optoelectronic coupling approach has been favored. In this approach, a LED and a photodiode are used to transmit data across the isolation interface. However, the optoelectronic coupling approach has a number of drawbacks. It uses high power. Fast LEDs are expensive. LEDs in general have limited operating lifetimes and large temperature limitations.

Of the remaining approaches, inductive coupling appears to offer the best solution to the problems associated with the optoelectronic approach. The inductive coupling approach uses a transformer as the data bridge across the isolation interface. Data on one side of the transformer is encoded into very short digital pulses, transmitted across the transformer and decoded back into data at the other end. In an example of the inductive coupling approach, a transformer is used to transfer an AC signal from the logic in a high voltage machine system to the logic in a low voltage machine controller system. The inductor is designed with an air core and metal windings. The transformer relies on the magnetic field coupling between the windings to transfer digital data pulses between the two systems.

The inductive coupling approach is fast and inexpensive and utilizes low power. A drawback to this approach, however, is that the magnetic coupling of the transformers can be interfered with by an external magnetic field generated, for example, by a large machine motor in close proximity. If an external field from the high voltage machine system is present, it is possible that the transmitted data will become corrupted, eventually causing the entire system to fail.

### SUMMARY OF THE INVENTION

The present invention provides magnetic guard rings to reduce the susceptibility of a transformer-based data transmission to an externally generated magnetic field. The guard ring structure comprises strategically placed pieces of a ferrite material, such as NiFe, that surround the transformer and “steer” the external magnetic fields away from the transformer.

The features and advantages of the various aspects of the present invention will be more fully understood and appreciated upon consideration of the following detailed description of the invention and the accompanying drawings, which set forth an illustrative embodiment in which the concepts of the invention are utilized.

### BRIEF DESCRIPTION OF THE DRAWINGS

FIG. 1A is a top view drawing illustrating an embodiment of a ferro-magnetic guard ring structure in accordance with the concepts of the present invention.

FIG. 1B is a cross section drawing further illustrating the FIG. 1A embodiment of the present invention.

FIG. 2A is a top view drawing illustrating an alternate embodiment of a ferro-magnetic guard ring structure in accordance with the concepts of the present invention.

FIG. 2B is a cross section drawing further illustrating the FIG. 2A embodiment of the present invention

### DETAILED DESCRIPTION OF THE INVENTION

The present invention provides magnetic guard rings to reduce the susceptibility of a transformer-based inductive coupling data transmission to an externally generated magnetic field. The guard ring structure comprises strategically placed pieces of a ferrite material, such as NiFe, that surround the transformer and steer the external magnetic fields away from the transformer.

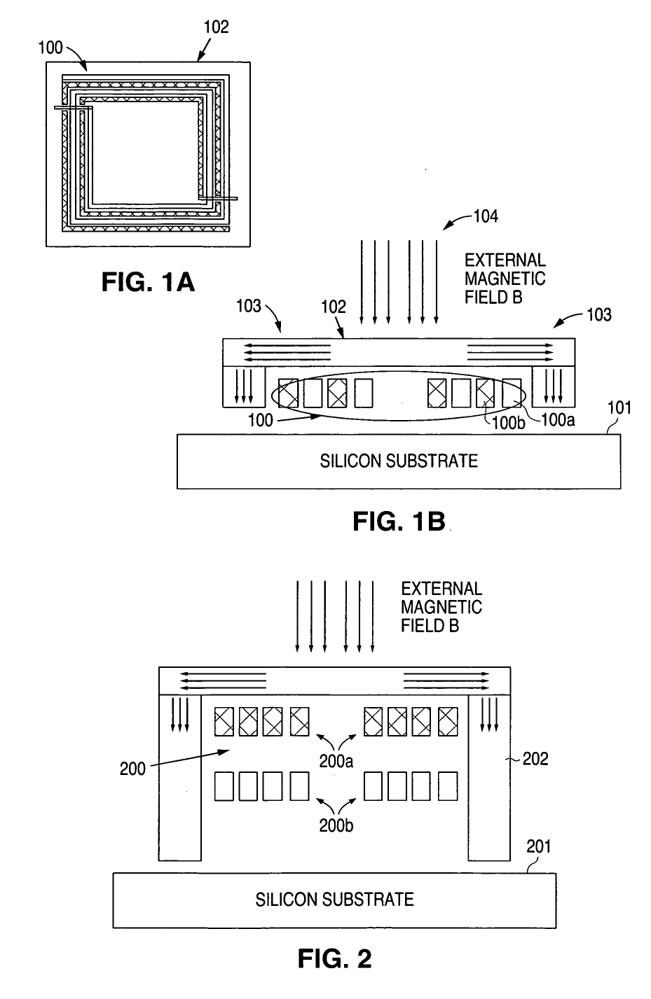

FIGS. 1A and 1B show a first embodiment of the present invention for protecting a core transformer device. In the embodiment shown in FIGS. 1A and 1B, the protected inductive coupling device 100, which is formed above a silicon substrate 101 in manner well known to those skilled in the art, is encapsulated by a ferro-magnetic guard ring 102. As shown in FIG. 1B, the flux lines 103 from an external magnetic field B 104 are constrained to within the ferro-magnetic guard ring 102, which acts as a shield to the protected transformer device 100.

Those skilled in the art will appreciate that there are a number of possible layout configurations for the inductive transformer device. The inductive device 100 shown in FIGS. 1A and 1B is an interwound transformer in which the primary winding 100a and the secondary winding 100b are formed in one planar layer of metal. To connect the terminals of the transformer 100, however, requires two layers of metal. The outer windings are connected to a Metal1 layer; the inner winding are connected to a Metal2 layer through a via. High voltage is on one side and low voltage on the other. In this case, the input and output could be swapped.

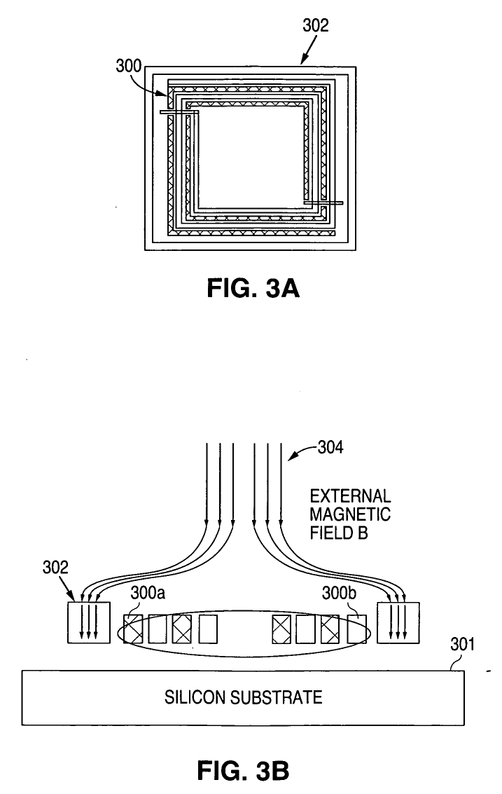

A second embodiment of an inductive transformer design 200, formed above a silicon substrate 201 in the well known manner and surrounded by a ferro-magnetic guard ring 202, is shown in FIG. 2. In the FIG. 2 embodiment, in this design, the high voltage (HV) windings 200a are on top of the low voltage windings 200b. The top metal layer for the HV windings 200a could be made thicker than the bottom metal layer for the LV windings 200b; this would be a more typical transformer design.

FIGS. 3A and 3B show an alternate embodiment of the present invention in which a ferro-magnetic guard ring structure 302 is formed around the periphery of the inductive coupling device 300 to be protected. Again, the coupling device 300 is formed above a silicon substrate in the well known manner. FIG. 3B shows how the flux lines 304 of an external magnetic field B are affected by the ferro-magnetic guard ring 302 and are “bent” away from the protected inductive device 302. FIG. 3B shows the primary winding 300a and the secondary winding 300b of the coupling device 300 to be interwound as described above.

In each of the above-described embodiments of the invention, it is preferable that the inductive transformer have ferro-magnetic material underneath as well as above and to the sides to fully encapsulate the transformer. However, those skilled in the art will appreciate that design issues related to the fabrication technology may prevent this. The ferro material should be some distance away from the transformer windings so as not to effect the inductance coupling factors. Since the distance between the metal and the silicon substrate is fixed for the typical fabrication technology, forming ferro material in this small defined space underneath the transform may effect the coupling factors. Placing the ferro material above and at the sides of the transformer means that the transformer could be a module that is formed in accordance with existing fabrication technologies.

The ferro-magnetic material utilized in each of the above-described embodiments of the invention is preferably NiFe a minimum of about 4μ thick with composition 80:20, relative permeability ur>800 and Bsat>1 Tesla. Those skilled in the art will appreciate that other readily available ferro-magnetic materials are also utilizable in implementing the concepts of the present invention

The present invention enables an air core transformer to operate in an environment with a much higher external magnetic field.

It should be understood that the particular embodiments of the invention described above have been provided by way of example and that other modifications may occur to those skilled in the art without departing from the scope and spirit of the invention as express in the appended claims and their equivalents.

What is claimed is:

1. An inductive coupling data transmission system for transferring data between a first system and a second system, the inductive coupling data transmission system comprising:
a transformer structure having a first winding coupled to the first system and second winding spaced apart from the first winding to define a gap therebetween and coupled to the second system; and
a ferro-magnetic guard ring structure disposed in proximity to the transformer such that a magnetic field that is external to the transformer is diverted away from the transformer by the ferro-magnetic guard ring structure.

2. An inductive coupling data transmission system as in claim 1, and wherein the ferro-magnetic guard ring structure is formed above and at the sides of the transformer structure.

3. An inductive coupling data transmission system as in claim 1, and wherein the ferro-magnetic guard ring structure encapsulates the transformer structure.

4. An inductive coupling data transmission system as in claim 1, and wherein the ferro-magnetic ring is formed to extend around the periphery of the transformer structure.

5. An inductive coupling data transmission system of claim 1, and wherein the ferro-magnetic guard ring structure comprises NiFe.

6. An inductive coupling data transmission system of claim 1, and wherein the ferro-magnetic guard ring structure comprises NiFe with composition 80:20.

7. An inductive coupling data transmission system of claim 1, and wherein the ferro-magnetic guard ring structure comprises a ferro-magnetic material having a permeability ratio relative to air of greater than 800:1.

8. An inductive coupling data transmission system as in claim 1, and wherein the ferro-magnetic guard ring structure comprises ferro-magnetic material having Bsat greater than 1 Tesla.

9. An inductive coupling data transmission system as in claim 1, and wherein the transformer structure comprises interwoven primary and secondary windings.

10. An inductive coupling data transmission system as in claim 1, and wherein the transformer structure comprises a primary winding formed in a first plane and a secondary winding formed in a second plane.
